(19) United States
(12) Patent Application Publication
(10) Pub. No.: US 2010/0275854 A1
(43) Pub. Date: Nov. 4, 2010

(54) Wildlife house "front porch" Guard

(76) Inventor: Ralph Charles Schlemper, St. Louis, MO (US)

Correspondence Address: RALPH C. SCHLEMPER, 2706 OTTER CREEK COURT, ST. LOUIS, MO, 63129, US

(21) Appl. No.: 12/387,126

(22) Filed: Apr. 29, 2009

(51) Int. Cl. A01K 1/00

(52) U.S. Cl. 119/428

(57) ABSTRACT

Provides a “front porch” device to wildlife houses for required predator protection and weather protection to the house entrance while utilizing the design to incorporate complete gable venting of the house. The invention consists of a gable roof with a front panel set away from the front face and outside of the wildlife house to deter predator access and provide a shield to the weather over the house entrance. The front panel is supported on the bottom or sides by mounting members of required thickness. The “front porch” is spaced away from the front face of the house at a distance which allows ease of passage or has an opening for passage of the wildlife for which it is provided.

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISC APPENDIX

“Not Applicable”

### BACKGROUND OF THE INVENTION

Provide an aesthetically pleasing predator and weather guard for a wildlife house(s) which incorporates complete gable venting of the house(s).

This device eliminates wire like materials which may rust away and/or create areas for entrapment of wildlife. Device is fixed, permanent, and has no moving parts which may become non-functioning over an extended period of time due to wear. Additionally, this device incorporates weather protection for the house entrance by providing a shield/cover over the house face while allowing complete venting of the house to prevent heat build-up due to high ambient temperatures and/or direct exposure to the sun. Drain slots in floor of house directly behind front of house, maximize drainage of any precipitation which enters thru vent aperture and runs down the inside face of the house.

### BRIEF SUMMARY OF THE INVENTION

Invention provides a “front porch” guard which can be positioned at varying distances from front face of the wildlife house. The “front porch” consists of a gable roof, porch face, and porch mounting member(s). The above described design allows increased or decreased guarding against predator access as required for each individual species and in addition said device provides weather protection to house entrance. Species access is provided by an opening in the porch face or by relocation of the mounting member(s) of porch to sides versus the bottom allowing bottom entry. Device also incorporates complete venting of the wildlife house while maintaining significant protection of the vent from the weather.

Increased or decreased predator guarding is accomplished during construction of the house by positioning face of “front porch” in desired location relative to the face of the house while assembling the house by changing the depth of the “front porch” mounting member(s). The relative location of the face of the “front porch” to the face of the house varies depending on the species of wildlife for which the house is provided.

Type of mounting member(s) used (bottom or side) can be modified to meet entry requirements for each individual species by placing mounting member(s) either at the bottom or at the sides of the “front porch” face. Device can be adapted to each individual wildlife species, both birds and animals, by adjusting the relative location of the “front porch” front from the front of the house and varying the size of the “front porch” front to the proper size relative to the house itself.

All parts of the “front porch” are wooden, do not incorporate the use of wire or similar materials, and have no moving parts, therefore, deterioration by rusting and accidental entrapment of wildlife is eliminated.

### BRIEF DESCRIPTION OF THE SEVERAL VIEWS OF THE DRAWINGS

FIG. 1 Front View of Wildlife House w/Bottom Support/Attachment Member And Front Entrance Hole

FIG. 2 Side View of Wildlife House w/Bottom Support/Attachment Member And Front Entrance Hole

FIG. 3 Front View of Wildlife House w/Side Support/Attachment Member And Bottom Entrance to Front Porch

FIG. 4 Side View of Wildlife House w/Side Support/Attachment Member And Bottom Entrance to Front Porch

### DETAILED DESCRIPTION OF THE INVENTION

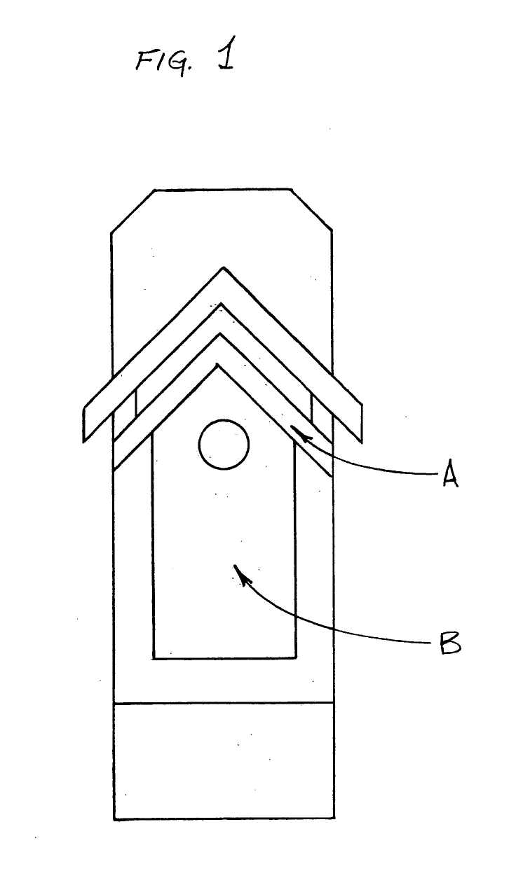

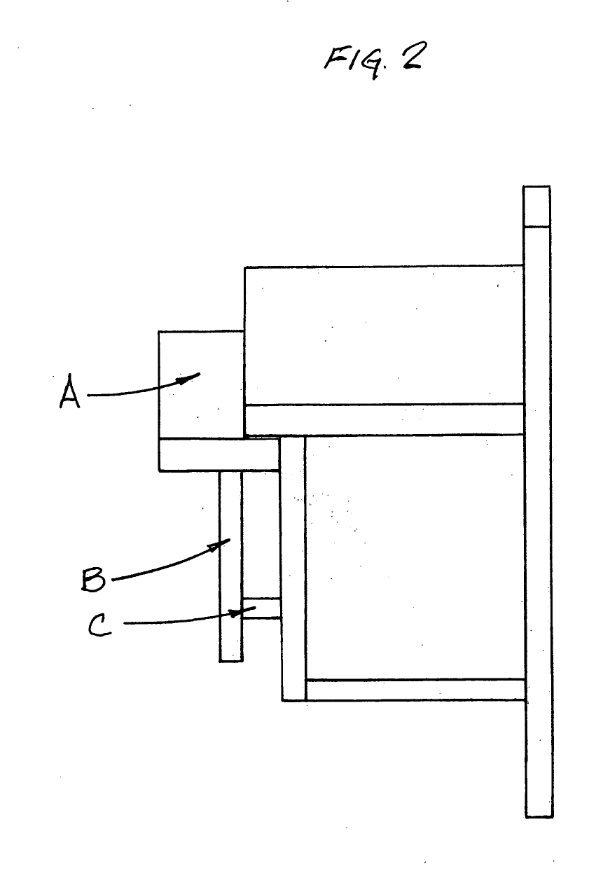

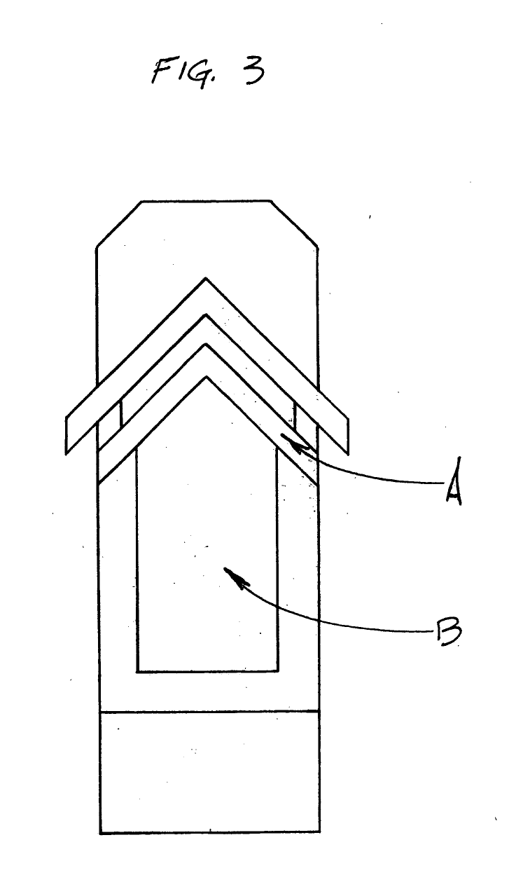

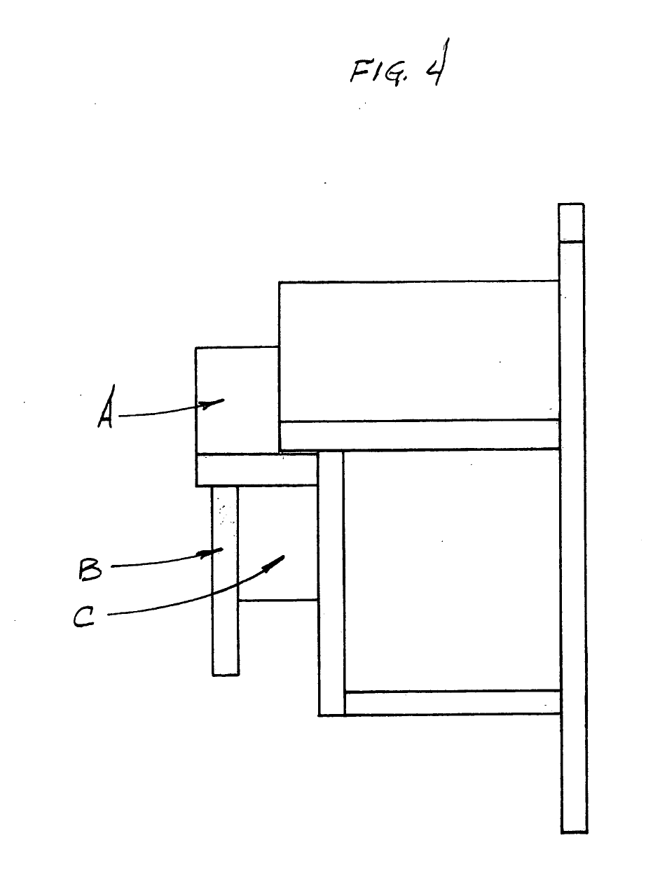

This invention utilizes a shortened front panel on the wildlife house itself with attached “front porch”. The shortened front panel provides a small gap between the house gable roof (which provides a weather shield for the vent) and the house front panel for complete venting of the structure. The “front porch” gable roof extends out from the front panel of the house just below the house gable roof providing a vent aperture while disallowing significant weather penetration. The front panel of the “front porch” device, can be located as required at varying distances from the house front thereby limiting predator access to the wildlife house as required for any given species of wildlife for which the house is designed. The front panel of the “front porch” device also provides substantial weather protection for house entrance. The parts of the “front porch” consist of the gable roof (A), the front (13), and the mounting member(s) (C) all securely fastened together and integral to the house front thereby creating the “front porch” device. The “front porch” may or may not have an entrance hole depending on wildlife species for which the house is designed. When the entrance hole is used in the “front porch” (FIG. 1), a bottom mounting member (FIG. 2) is used. If entrance hole is not used in the “front porch” (FIG. 3) side mounted mounting members (FIG. 4) are utilized thereby allowing bottom entry of the “front porch”

The “front porch” front location from the front panel of the wildlife house is varied by changing the depth of the mounting member and the corresponding fastening location of the front panel to the “front porch” gable roof. The “front porch” gable roof is extended as required to facilitate proper fastening of the front to the gable roof section of the “front porch” device. This allows the front panel to be positioned at the location desired for any given species of wildlife for which housing is being provided. The configuration of all houses remains the same only the position of the “front porch” front will differ as needed, the variation is dimensional only. When an individual species of wildlife requires bottom entry versus front entry to the house, the mounting member(s) are relocated from the bottom of “front porch” front to the sides of the front. This allows the wildlife to enter from the bottom of the device rather than from the front. This configuration requires two (2) mounting members versus one (1) mounting member as required of front entry type housing. All other criteria for the bottom entry type housing remains the same.

1. “Front porch” device exterior to house provides varying degrees of predator protection to wildlife houses as required for any individual species of wildlife for which the house is provided while allowing passage of wildlife species for which housing is provided.

2. “Front porch” device exterior to house provides substantial weather protection to wildlife house entrance by shielding face of house and house entrance.

3. “Front porch” device incorporates complete gable ventilation to wildlife house by shortening front of house below gable roof of house and fastening gable roof of “front porch” flush with top of house front creating a narrow aperture between the two gables for complete house ventilation.
